(19) United States
(12) Patent Application Publication
(10) Pub. No.: US 2012/0194112 A1
(43) Pub. Date: Aug. 2, 2012

(54) Electrical Brushless Motor

(75) Inventor: Madhur M. Purohit, Sparks, MD (US)

(73) Assignee: ELECTRICAL SYSTEMS INTEGRATOR LLC, Sparks, MD (US)

(21) Appl. No.: 13/357,744

(22) Filed: Jan. 25, 2012

Related U.S. Application Data
(60) Provisional application No. 61/436,648, filed on Jan. 27, 2011.

(51) Int. Cl. H02P 6/18; H02K 5/22; H02K 29/08; H02K 7/08; H02K 11/00

(52) U.S. Cl. 318/400.32; 310/90; 310/68 B; 318/400.38; 310/68 D

(57) ABSTRACT

An electrical brushless motor is described, as well as a ceiling fan utilizing the electrical brushless motor.

This application claims the benefit under 35 U.S.C. §119(e) of prior U.S. Provisional Patent Application No. 61/436,648, filed Jan. 27, 2011, which is incorporated in its entirety by reference herein.

### BACKGROUND OF THE INVENTION

The present invention relates to brushless motors and new configurations and designs. The present invention further relates to ceiling fans and other devices that contain the brushless motor(s) of the present invention.

Traditional ceiling fans use induction motors as their prime movers. Ceiling fans as the name suggests are typically hung on the ceiling and have blades mounted on the periphery of the motor to generate airflow. Ceiling fans currently available in the market are capable of different speed settings, typically 3 or 4 distinct speeds. Typically they run in both clockwise and counter-clockwise direction to provide downdraft in the summer time and updraft in the winter time. In addition, most of the fans have a down or up light on them whose intensity can be changed. Changing the speed setting, direction or turning the light on and off is achieved through various user interactions. Most commonly, the user can use a pull chain switch to change the speed and turn the light on and off while a slide switch can be used for direction control. Some ceiling fans work with hand held or wall mounted remote controls which can provide all these functions to the user with a press of a button. All these different configurations require different electrical connection schemes. To be able to design a motor that can be adapted to these various configurations with minimal changes is often difficult. With the advent of energy efficiency regulations (energy star compliance requirements), the need for using more and more efficient motors is rising. Brushless motors which are much more efficient than their counterpart induction motors are gaining popularity for the ceiling fan applications. Use of brushless motors for a ceiling fan can meet the present day energy star requirements of efficiency; however gain in this efficiency is not free. Brushless motors are more expensive than induction motors. Also, they use an electronic control module to commutate the motor. The electrical interconnections become more complicated than induction motors due to the electrical interconnections between the user interface and the control, and additional interconnection schemes are required for the motor and the motor controller. The traditional construction of a brushless motor for the ceiling fan thus provides a lot of challenges in terms of electrical wire-up to achieve all the functionality of the ceiling fan with various user interfaces.

FIG. 1 shows a conventional fan with an outer rotor construction which means the rotating part of the motor (rotor) is placed circumferentially outward of the fixed portion of motor (stator) that is connected to central shaft. The central shaft is fixed by mounting it directly to the down rod which connects to the ceiling. The blades are attached to the rotor. The power to the fan and light comes from the top (ceiling). The power connection wires pass through the central hole in the shaft. The connection with the pull chain circuit is done below the blades where the user can reach safely. Thus, it is almost mandatory to have a hollow shaft to pass wires through. In the case of a typical induction motor based ceiling fan, a maximum of 7 to 8 wires can be passed through the hollow shaft.

Brushless motors need a control module to commutate the motor. 3 phase brushless motors are the most popular form of brushless motors which use 6 electronic switches to control the commutation. The switches control the motor current by alternately energizing the circumferentially placed winding on the stator and create a rotating magnetic field in the stator windings. The rotor has alternating permanent magnets that rotates due to the rotating magnetic field. The control module needs to know the position of the rotor especially during the start up time to start commutating the windings. This needs some kind of position sensing mechanism of the rotor. A Hall Effect type of sensor is the most popular. The sensing scheme in conventional brushless motors required additional wires for this connection between the motor and the motor controller.

FIG. 1 shows a traditional brushless motor cross section. In this figure, a brushless motor for a ceiling fan (1) is shown. Attached to a hollow shaft (3) is a bottom bearing (5) and a top bearing (7). A stator (9) is located in between the two bearings (5, 7). Located above the stator and in contact with the stator is a motor coil(s) (11). As further shown in FIG. 1, a bottom bearing bridge (13) is attached to the bottom bearing and supports the rotor assembly in connection with the top bearing bridge (15). A Hall sensor board (17) and the stator are connected by various wires (19) to a control board (21). As shown in FIG. 1, the wires from the Hall sensor board pass through the hollow shaft (3) in order to have access to the control board (21). The wires (19) also are in connection with the stator motor coil (11). A control board support (23) supports the control board (21), as well as the receiver board (25). As shown in FIG. 1, the stator is located in between the bottom bearing (5) and the top bearing (7) and in order to operate the stator (9)/motor coil (11), wires are connected and pass through the hollow shaft to the control board (21). Properly routing these wires through the cross-drilled holes into the hollow shaft and again dressing them properly into the control board is both cumbersome and labor intensive.

Thus, there is a need to overcome one or more of these obstacles and to provide a brushless motor and ceiling fan that can achieve the benefits of a brushless motor but avoid the many disadvantages of using such a configuration. The present invention is different from the prior art in terms of the way the motor is constructed. The present invention allows not only easy execution of various configurations including the use of a pull chain and/or a remote control but also simplifies assembly, reduces number of parts, and thus reduces the overall cost of the system.

### SUMMARY OF THE PRESENT INVENTION

A feature of the present invention is to provide a new brushless motor design that can be used in various configurations and which minimizes the number of wires passing through the axis or shaft of the brushless motor device.

A further feature of the present invention is to provide a brushless motor device, which simplifies the overall wiring.

An additional feature of the present invention is to provide simplified interconnections between the motor and motor controller, as well as other components of the brushless motor device.

A further feature of the present invention is to provide brushless motor devices, such as ceiling fans, which have a smaller overhang.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a ceiling fan with an outer-rotor type DC brushless motor. The ceiling fan can include:

at least one blade; and an outer-rotor type DC brushless motor as a driving source for the ceiling fan, wherein the outer-rotor type DC brushless motor is mounted on a shaft and comprises a stator having an axis and multiple stator windings; and a rotor assembly rotatably mounted on the shaft through bearings. The rotor assembly can include:

a circular casing with an inner periphery, wherein the circular casing includes a permanent magnet(s) on the inner periphery and interacting with the stator windings of the stator; and

at least one bearing provided in the inner space of the circular casing and located beneath said stator, and wherein all bearings present are located on the same side of the stator. The ceiling fan can further include a motor controller connected to at least one rotor position sensor to detect the position of the rotor or a permanent magnet and based on detected results, the motor controller accordingly changes current of the stator windings to produce magnetic fields required to drive the rotor assembly and the at least one blade. As an option, the ceiling fan or the brushless motor of the present invention can have a sensor-less motor, wherein no rotor position sensor is used.

The present invention further relates to a ceiling fan with an outer-rotor type DC brushless motor, wherein the ceiling fan includes:

at least one blade; and

an outer-rotor type DC brushless motor as a driving source for the ceiling fan, wherein the outer-rotor type DC brushless motor is mounted on a shaft. The brushless motor includes a stator having an axis and multiple stator windings; and

a rotor assembly rotatably mounted on the shaft. The rotor assembly includes:

a circular casing with an inner periphery, and

having a permanent magnet(s) present on the inner periphery and interacting with the stator windings of the stator; and

at least one bearing provided in the inner space of the circular casing and wherein all bearings present are located on the same side of said stator. The ceiling fan can optionally include a motor controller connected to at least one rotor position sensor to detect the position of the rotor or a magnetic pole and, based on detected results, the motor controller accordingly changes current of the stator windings to produce magnetic fields required to drive the rotor assembly and the at least one blade.

In addition, the present invention relates to an electrical brushless motor comprising a stator having an axis and multiple stator windings; a circular casing with an inner periphery, and having a permanent magnet(s) present on the inner periphery and interacting with the stator windings of the stator; and at least one bearing provided in the inner space of the circular casing and wherein all bearings present are located on the same side of said stator.

In addition, the present invention relates to an electrical brushless motor having a rotor-magnet arrangement optionally with a flux ring, wherein the permanent magnet has multiple spaced raised portions for purposes of being sensed by at least one rotor position sensor should this option be present.

Further, the present invention relates to an electrical brushless motor having one or more features or components described herein.

Also, the present invention relates to devices that utilize the electrical brushless motor of the present invention, such as ceiling fans and the like.

It is to be understood that both the foregoing general description and the following detailed description are exemplary and explanatory only and are intended to provide a further explanation of the present invention, as claimed.

The accompanying drawings, which are incorporated in and constitute a part of this application, illustrate features of the present invention and together with the description, serve to explain the principles of the present invention.

### BRIEF DESCRIPTION OF DRAWINGS

FIG. 1 is a break-away view of a prior art brushless motor.

FIG. 2 is a break-away view of a brushless motor of the present invention.

FIG. 3 is a cut-away perspective view of a brushless motor of the present invention.

FIG. 4 is a breakaway view of a brushless motor of the present invention showing an inverted construction compared to the design in FIG. 2.

FIG. 5 is a perspective view of a brushless motor that can be part of a ceiling fan of the present invention.

FIG. 6 is a perspective view of a flux ring with permanent magnets having raised portions which can comprise an option of the present invention.

FIGS. 7 and 8 are perspective views of a retainer used with a flux ring that is an option in the present invention.

FIG. 9 is a break-away view of a further example of a brushless motor of the present invention.

FIG. 10 is an exterior perspective view of the brushless motor of FIG. 9.

### DETAILED DESCRIPTION OF THE PRESENT INVENTION

The present invention relates to electrical brushless motors having unique and beneficial designs, and also relates to devices that utilize the electrical brushless motor, such as ceiling fans.

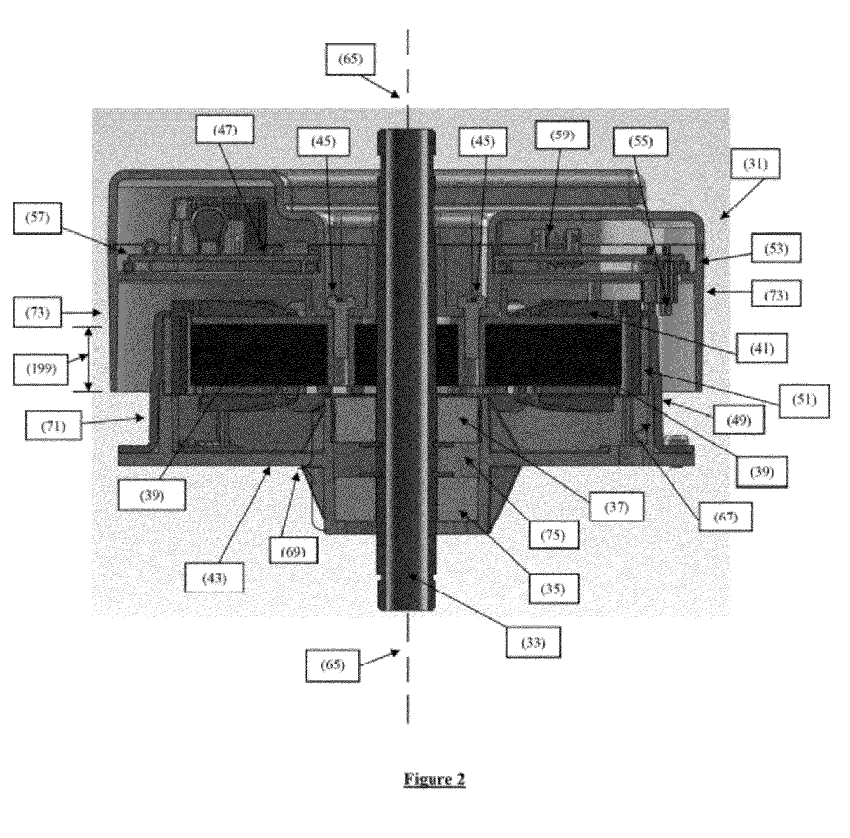

In more detail and with reference to the figures, wherein the figures are simply exemplary and non-limiting of the present invention, in FIG. 2, a brushless motor of the present invention is shown. In FIG. 2, an electrical brushless motor (31) includes a stator (39) having an axis (65). The axis is in line with the shaft (33), which can be a hollow or solid shaft (33). The electrical brushless motor (31) further includes multiple stator windings (41) or motor coils (41). A circular casing (49) with an inner periphery (67) has a permanent magnet(s) (51) present on the inner periphery (67) and interacting with the stator windings (41) of the stator (39). The electrical brushless motor (31) of the present invention further includes at least one row of bearings (also referred to as bearing 37 and/or 35) provided in the inner space (69) of the circular casing (49). In the electrical brushless motor of the present invention, all bearings (e.g., 35 and/or 37) that are present are located on the same side (side 71 or side 73) of the stator (39).

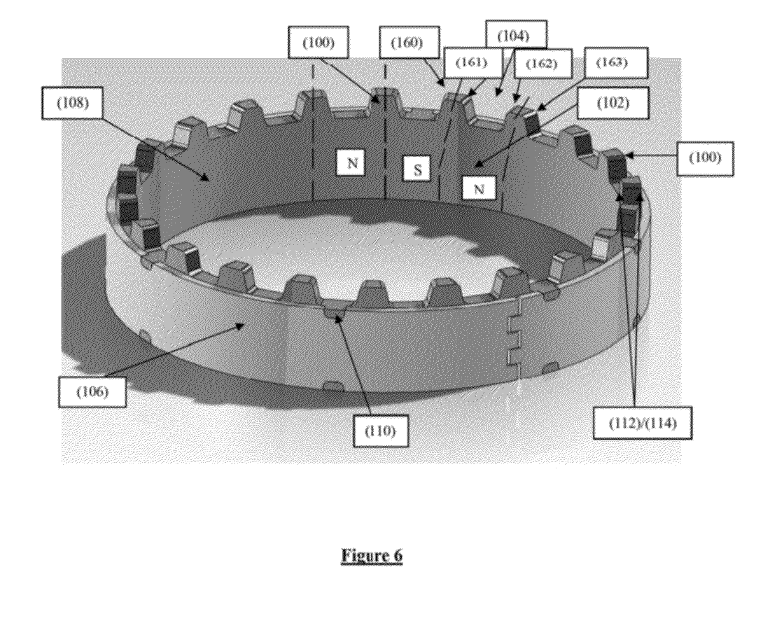

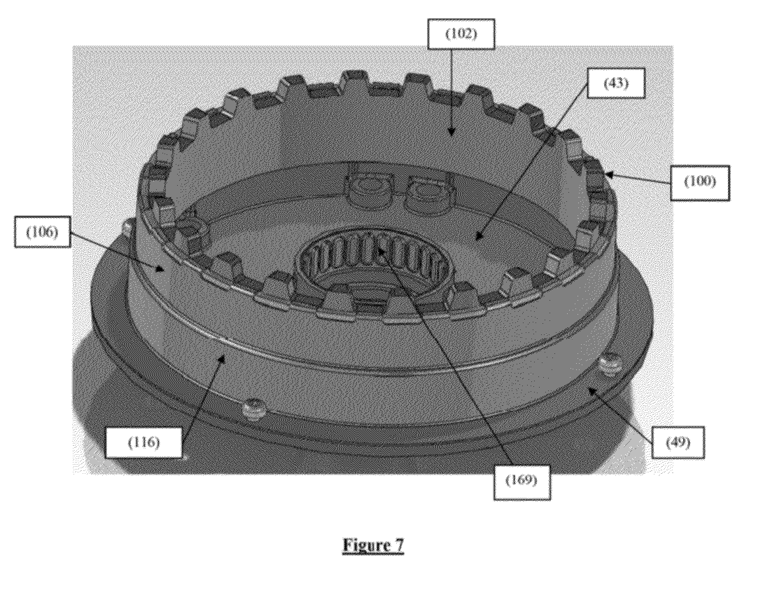

In more detail, as an option, the at least one bearing (or row of bearings) can comprise a top bearing (37) and a bottom bearing (35), which is provided in the inner space (69) of the circular casing (49). Both top bearing (37) and bottom bearing (35) are located on the same side (side 71 or side 73) of the stator (39). The top bearing and bottom bearing can provide cantilever support of the rotor or rotor assembly as defined by the circular casing (49) and bearing bridge (considered a bearing bracket) (43) or center base (43), which can receive, in the case of a ceiling fan, the multiple blades. For purposes of the present invention, the circular casing can be or can include a retainer (e.g., retainer (116) in FIG. 7), the permanent magnet(s), the casing holding the permanent magnet(s), the flux ring (e.g., flux ring (106) in FIG. 6), and/or bearing bridge (e.g., bearing bridge (43) in the figures), or it can be any combination of these various components. In other words, the circular casing can solely be a casing holding the permanent magnet or can solely be the flux ring, or solely can be the bearing bridge, or solely be the retainer, or be a circular casing that can include the retainer, or permanent magnet(s), or flux ring, or bearing bridge, or any combination thereof. When the circular casing is referred to herein, it is with these various design options or features. Thus, the circular casing can be a casing holding the permanent magnet or can be a casing that includes the permanent magnet or other components mentioned herein. Further, with respect to the permanent magnet (51), it is to be understood that the permanent magnet can comprise a single magnet or can comprise multiple permanent magnets bonded or otherwise joined together. The permanent magnet can be a single magnet having multiple magnetic poles which, in the present application, would be multiple alternating magnetic poles for purposes of interacting with the stator windings to produce a magnetic field required to drive the rotor assembly. Thus, for purposes of the present invention, when the term “permanent magnet” is mentioned, it is to be understood that this includes a single permanent magnet having multiple regions/zones/sections that have alternating magnetic poles or can be a permanent magnet comprised of multiple magnets with alternating magnetic poles facing the stator. Essentially, for purposes of the present invention, the circular casing can be considered part of the rotor assembly and which involves a structure that encircles the stator.

As shown in FIG. 2, at least one bearing (35 and/or 37) can be provided in the inner space (69) of the circular casing (49) and be located beneath the stator (39). For purposes of the present invention, the term “beneath the stator” is a reference to the locations below the stator (39) as shown by the arrow (71) and relative to the axis (65). This space is below the stator. For purposes of the present invention, the space above the stator is area 73 as shown in FIG. 2, for instance.

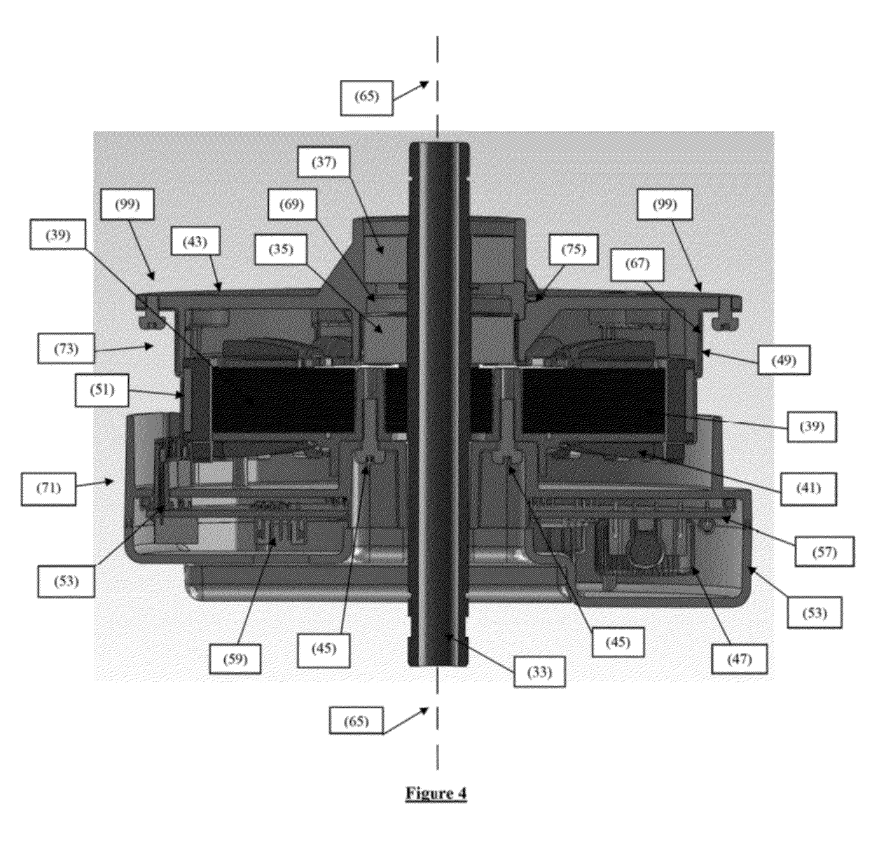

As another option, at least one bearing (35 and/or 37) can be provided in the inner space (69) of the circular casing (49) and be located above (area 73) the stator (39) as shown in FIG. 4.

As shown in FIG. 2, for instance, the top bearing (37) and the bottom bearing (35) can be spaced apart from each other where, for instance, area (75) represents the space in between each bearing. The distance of the top bearing from the bottom bearing can be any distance, such as from about 0 mm to about 10 mm.

The top bearing (37) and bottom bearing (35), if present, can be accommodated by a single bearing bridge (43), which can also be considered a bearing bridge or bearing bracket (43) or center base (43). For purposes of the present invention, it is understood that at least one bearing, such as a top bearing and/or bottom bearing, is a series or row of ball bearings that constitute a row or ring around the shaft in order to rotate around the shaft and support the rotor assembly. For purposes of the present invention, the bearing(s) of the present invention can include a tolerance ring which, for instance, is shown as 169 in FIG. 7. As an option (not shown), multiple bearing bridges can be used for each bearing. The single bearing bridge or bearing bracket can be made from any suitable material. For instance, in the case of the electrical brushless motor being used for a ceiling fan to hold the multiple blades, the bearing bridge can be made from metal, plastics, fiberglass, and the like.

The electrical brushless motor of the present invention can further comprise a motor controller or control module (47) as shown in FIG. 2, for instance. As an option, no moving parts are located between the stator (39) and the motor controller (47). The reference to no moving parts includes no bearings or other parts that would move about an axis, such as axis 65 in FIG. 2.

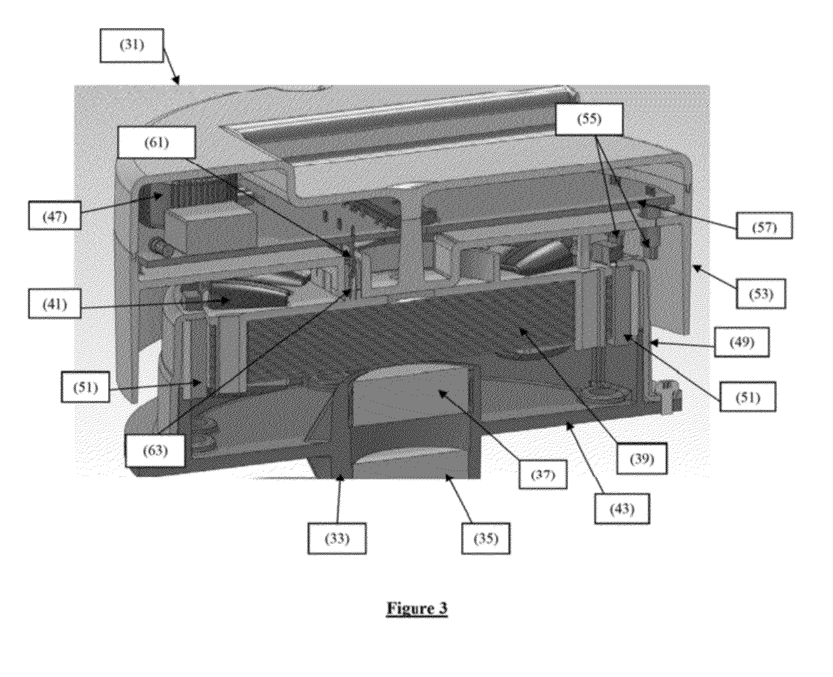

A motor controller (47) can be in communication with the stator in any conventional way. As an option, the motor controller (47) is connected through electrical terminals to the stator as shown, for instance, in FIG. 3, where, as a specific example, tulip terminal (63) is connected to the stator (49) and, in turn, the terminals are connected to a control module (47), which is part of a printed circuit board (57). As stated, the motor controller (47) or control module (47) can be part of a control printed circuit board (57) as shown in FIGS. 2 and 3, for instance. As an option, the stator can be connected to a separate printed circuit board, and this separate printed circuit board can then in turn be connected to a control printed circuit board. As an option, the electrical brushless motor can comprise one or more rotor position sensors (55), which can be, for instance, a Hall sensor or optical sensor or the like. Preferably, the rotor position sensor(s) is a Hall sensor and, more preferably, is at least three rotor position sensors located adjacent to each other, for instance, as shown partially in FIG. 3. The rotor position sensor (55) can be a magnetism sensor that detects the polarity of the portion of the permanent magnet (51) that is adjacent to the magnetism sensor (55). The rotor position sensor (55) can be connected to the motor controller (47) without wires or with wires. For instance, the rotor position sensor (55) can be connected to the motor controller (47) through electrical terminals, for instance, through the use of electrical tracks (not shown) on a printed circuit board (57). As shown, for instance, in FIGS. 2 and 3, the rotor position sensor (55) can be mounted directly on a control printed circuit board (57). The motor controller (47) that can be a control printed circuit board (57) and the stator (39) can be connected to the control printed circuit board (57), for instance, by terminals or other electrical connection means (e.g., wires, solder points). Stator (39) can be connected to the control printed circuit board (57) through terminals (63) that mate directly with terminals (61) on the control printed circuit board (57).

As one option, the motor controller (47) can be located and/or mounted above or over the stator (39) as shown in FIG. 2. As an option, the motor controller (47) can be mounted below the stator (39), for instance, as shown in FIG. 4. As shown in FIG. 4, the same components in an inverted fashion can be presented with the components numbered in FIGS. 2 and 3 have the same meaning as in FIG. 4 in this inverted construction. In FIG. 4, the blade mounting is present at the top of the brushless motor design and indicated by blade mounting locations (99).

The permanent magnet (51) that is on or a part of the inner periphery (67) of the circular casing (49) can have an even number of magnetic poles, such as 8 or more magnetic poles (e.g., 10, 12, 14, 16, 18, 20, 22, or 24 magnetic poles) that are present at the inner periphery (67). The magnet can be mounted on a flux ring (106) as shown in FIG. 6.

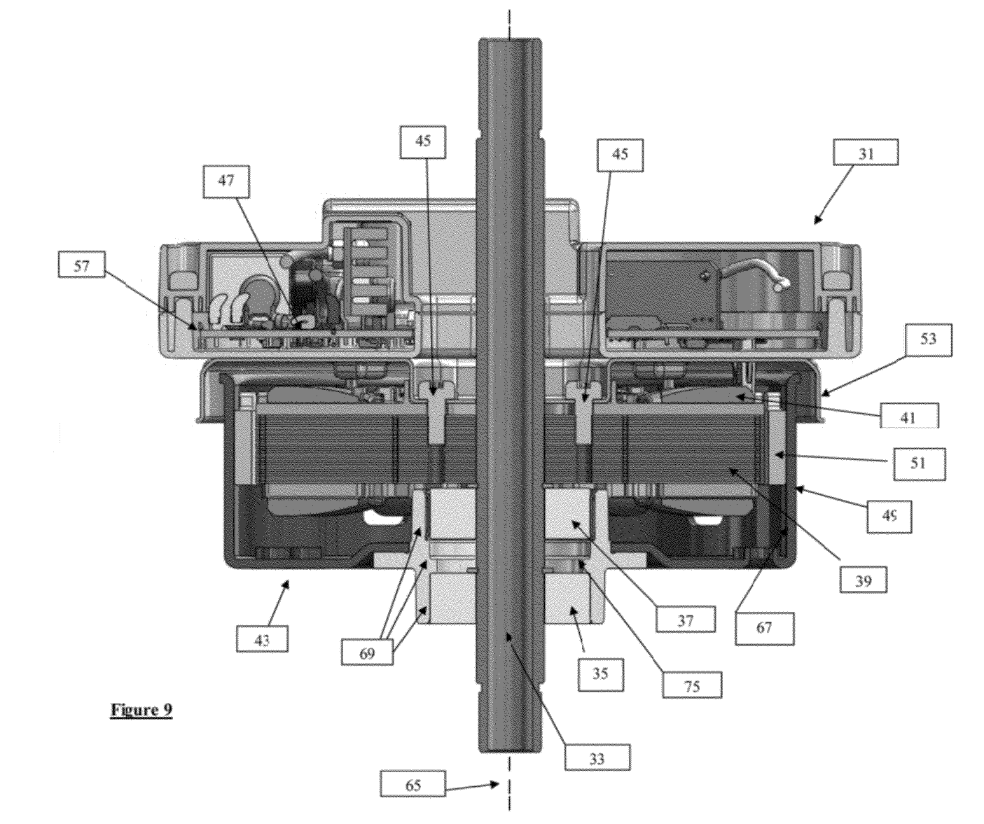

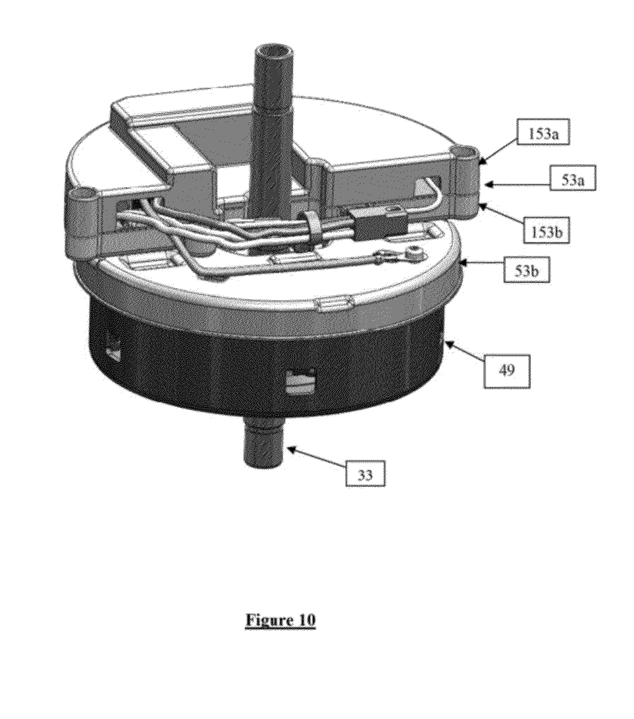

FIGS. 9 and 10 show a further example of an electric brushless motor of the present invention. The numerals represent like features as in FIGS. 2 and 3. In FIGS. 9 and 10, a short skirt (53) is used and FIG. 10 shows two parts of the skirt—53a, the top skirt; and 53b, a bottom skirt, which are removably connected together to house the control module. 53a can further have a top (153a) and bottom (153b) that are removably connected together.

As an option, in the present invention, the rotor assembly can have a small overhang with respect to the at least one bearing. More specifically, the overhang is defined as the distance from the bearing surface closest to the stator to the surface of the magnet most further away from the stator. In FIG. 2, this is shown as line 199. This overhang can, for instance, be a distance of from 10 mm to 30 mm, or from 10 mm to 20 mm, or from 15 mm to 30 mm, or any distances outside these ranges. With the present invention, this overhang can be quite small.

As an option, the motor controller (47) which can be part of a printed control board (57) can be part of a skirt (53) that removably connects to the stator (39) area as shown, for instance, by the use of screws or other attachment devices (45). The axis (65), as indicated, can be a shaft (33), such as a hollow or solid shaft (33), and, in the case of a hollow shaft, with an outer diameter and an inner diameter. The outer diameter can, for instance, be any suitable diameter, such as from 8 mm to 15 mm. The inner diameter can be any suitable diameter, such as from 5 mm to 9.5 mm. Other suitable outer diameters can be from 8 mm to 12 mm. Other inner diameters can be from 5 mm to 8 mm.

The top and bottom bearing, if used, can touch each other, can be adjacent to each other, or can be spaced apart, for instance, at lengths of up to 10 mm or more apart.

One or more bearings (i.e., one or more rows of bearings) can be used in the present invention to support the rotor assembly. For instance, one bearing, two bearings, three bearings, four bearings, or more can be used. For purposes of the present invention, it is understood that at least one “bearing,” such as a top bearing and/or bottom bearing, is a row or series of ball bearings that constitute a ring around a shaft in order to support the rotor assembly and rotate around the shaft. The row of ball bearings can be a taper roller bearings. Preferably, one or two bearings (rows of bearings) are used as shown in the figures. The bearings can be, for instance, 11 mm bearings or can be from 11 mm bearings to 15 mm bearings, or other diameter bearings. For instance, 6002 Series ball bearings can be used.

The row of bearings can be press-fitted onto the shaft (33). With the present invention, as an option, only one bearing bridge (13) is used, since the bearings are only on one side of the stator. This is unlike prior art designs which use at least two bearing bridges.

Thus, with the present invention, at least one bearing bridge can be avoided or eliminated and/or several wires can be eliminated, and/or a support plate that holds the printed control board can act as a skirt that removably connects to the stator as shown in the figures.

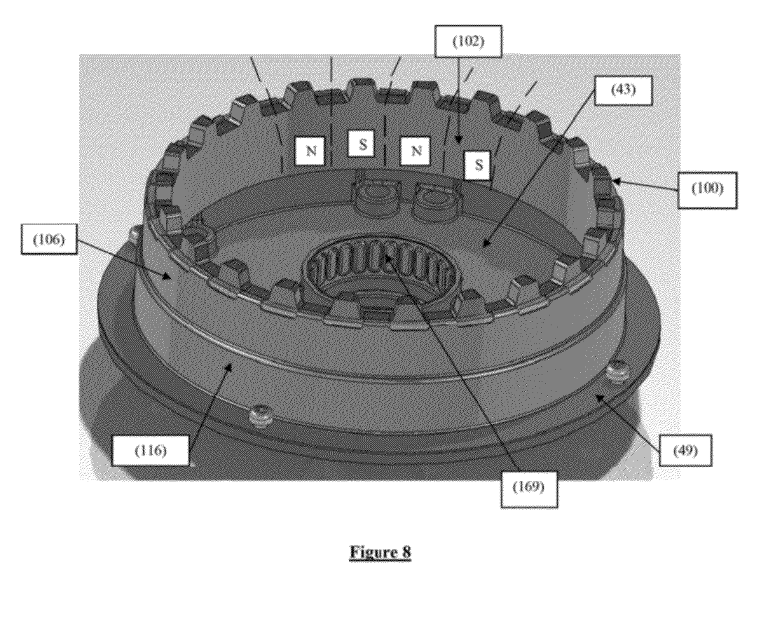

As an option, and as shown, for instance, FIGS. 6 and 7, the electrical brushless motor of the present invention can include a permanent magnet (102) having sections/regions/zones of alternating magnetic poles (N-S arrangements) facing the stator. In FIG. 6, a magnet having twenty-two magnetic poles is present in a circular arrangement and in an alternating pole arrangement. The magnet can have multiple raised portions (100) as shown in FIG. 6. These raised portions can have any geometry, such as trapezoidal, triangular, rectangular, and the like. This raised portion can advantageously be used for position sensing by at least one rotor position sensor, such as a Hall sensor. The advantage of having raised portions is that less magnetic material is used to create the magnet. In more detail, normally, the magnet has the same width throughout the length or height in alternating pole fashion. Generally, the magnet has a portion above, for instance, a flux ring, so that rotor sensor, such as a Hall sensor, can detect the polarity of that region of the magnet for purposes of the motor controller. However, this unnecessarily uses magnetic material at the upper portions of the magnet since this portion of the magnet is used only for sensing. With the present invention, as an option, the magnet can have multiple spaced raised portions as, for instance, shown in FIG. 6. Each raised portion can either be the same magnetic pole or half of the raised portion can be one magnetic pole and the other half of the raised portion can be the opposite magnetic pole so that when the raised portion is adjacent a magnetic sensor, such as a Hall sensor, the Hall sensor will first detect one pole and then detect the alternating pole. By having such an arrangement, the raised portions permit a magnetic sensor to detect where the magnetic pole begins and ends as the magnet rotates around the stator. For instance, as shown in FIG. 6, various broken vertical lines are shown to provide an understanding of how the alternating magnetic pole arrangement is set in the permanent magnet shown in FIG. 6. Even though only four broken lines are shown, it is to be understood that these zones would exist throughout the magnet as depicted and would provide the alternating pole arrangements. Further, with regard to the rotor sensor, as an example, the rotor sensor would detect the magnetic pole at point 160 which, in this example, would be a S magnetic pole. Then, at point 161, the rotor sensor would detect a change in the pole from a south pole to a north pole and would continue with the understanding of a north pole until point 162 is reached which would again confirm a north pole arrangement, and then upon reading the raised portion at point 163, would determine that a south pole arrangement has just occurred for purposes of communicating this to the motor controller. The benefit of this type of magnet design is that less magnetic material is used on the sensing portion of the magnet since this part of the magnet is only used for purposes of the magnetic sensor and is not used for purposes of interacting with the stator in order to create movement of the rotor. In the option where the entire raised portion (100) (e.g., in FIG. 6) is a magnetic pole, such as a north orientation, then, by having a gap 104 in between the raised portions (100), this creates a break in between magnets for purposes of the rotor sensor detecting the alternating polarity of the magnets. In both options, the rotor sensor detects the raised portion, for instance, north orientation, and maintains this sensing of north orientation until the next raised portion passes the sensor and then recognizes the south orientation and so on. This is shown in FIG. 8.

As shown in FIG. 6, a flux ring or flux enhancer (106) can be used on the outer diameter of the series of magnets bonded or aligned together. The flux ring can be part of the rotor assembly. The flux enhancer (106) is typically made from steel and has the ability to focus or concentrate the magnetic flux to the internal diameter area of the magnets (108) between the stator and magnets. As an option, interlocking features (110) can be used to secure the bonded magnets to the flux ring (106). As shown by (112) and (114), the raised portions (100) have an inner diameter and outer diameter for sensing by at least one rotor sensor. As further shown in FIG. 7, a retainer 116 can be used to hold the flux ring with magnets, and the retainer (116) is secured to a bearing bridge (43) in order to create the sub-assembly of the flux ring with permanent magnets, which ultimately is attached onto the bearing bridge for purposes of forming the rotor assembly. The retainer (116) essentially traps the flux ring and permanent magnets onto the bearing bridge and can be made from steel or other materials. The retainer or retainer plate (116) can be attached to the bearing bridge (43) using a variety of means including, but not limited to, screws, rivets, twist-lock features, or other non-fastener means, such as glue or adhesives.

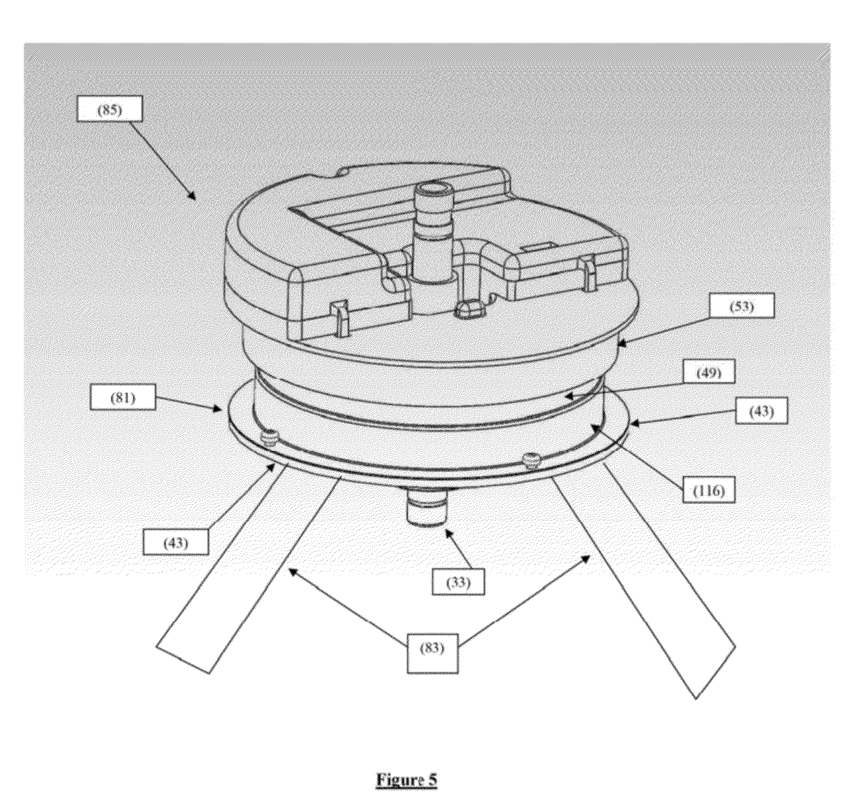

The electrical brushless motor of the present invention can be used as part of a ceiling fan that utilizes the outer rotor-type DC brushless motor design described herein and, for instance, as shown in the figures. The ceiling fan can comprise a center base or bearing bridge (43) upon which at least one blade or multiple blades (83) are attached to. As shown in FIG. 5, the overall electrical brushless motor is shown by (85), which would have the components of, for instance, FIG. 2 or 4. The outer rotor-type DC brushless motor, for instance, of FIG. 2 would be the driving source for the ceiling fan, wherein the outer rotor-type DC brushless motor is mounted on a shaft (33), such as by press fitting. As indicated, the outer rotor-type DC brushless motor comprises a stator (39) having an axis (65) which can be shaft (33) and multiple stator windings (41). A rotor assembly (comprising circular casing (49), permanent magnet (51), bearings (35 and/or 37), and bearing bridge (43), for instance), is rotatably mounted on the shaft (33). The rotor assembly, for instance, comprises the circular casing (49) with an inner periphery (67). The circular casing can be located, as shown in FIG. 2 and FIG. 5, above the center base (81) or bearing bridge (43) and the circular casing can be part of or can include the permanent magnet (51) present on the inner periphery (67) and the permanent magnet interacts with the stator windings (41) of the stator (39). The ceiling fan further includes at least one bearing provided in the inner space (69) of the circular casing (49) and can be located beneath the stator (39) or above the stator (39), for instance, as shown in FIG. 2 and FIG. 4, as well as FIG. 5 and FIG. 6. As shown in the various figures, all bearings (or rows of bearings) that are present are located on the same side of the stator (39). A motor controller as shown, for instance, in FIG. 2 can be connected to at least one rotor position sensor. The various features described above with respect to the electrical brushless motor and as detailed in FIGS. 2-4 can form part of the ceiling fan and, for purposes of the present invention, these various aspects of the motor will not be repeated here in order to avoid repetition.

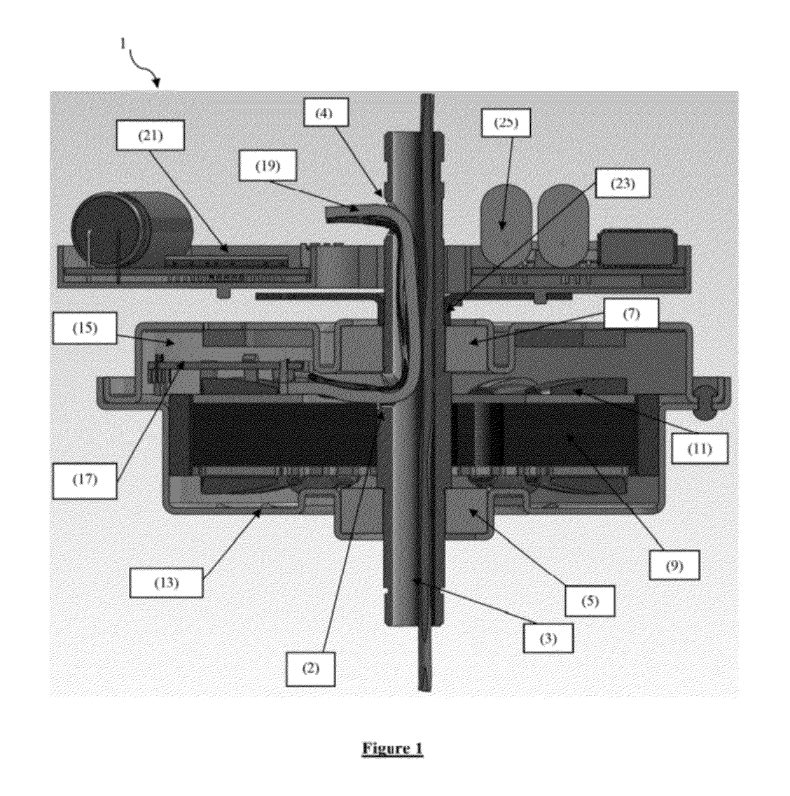

As shown in the figures, for instance, the present invention greatly reduces the number of wires that pass through the hollow shaft (33), since wires from the stator to the control module can be avoided and eliminated completely. Further, wires from the rotor position sensors to the control module can be eliminated completely. In addition, no boring of the hollow shaft in the stator area is needed in view of the design of the electrical brushless motor of the present invention. As shown, for instance, in FIG. 1, the shaft (3) typically has a bore hole in the shaft, and this can destabilize or weaken the shaft.

With the present invention, a smaller diameter shaft with respect to the outer diameter and inner diameter can be used in view of the design and in view of the fact that fewer wires pass through the shaft or a solid shaft can be used. With the present invention, a remote control sensor or other type of device can be part of the printed control circuit board. Other options typically found in electrical brushless motors can be included in the design of the present invention. Similarly, other features typically found in ceiling fans, such as pull chains, remote controls, lights, and the like, can form part of the ceiling fan of the present invention.

The present invention includes the following aspects/embodiments/features in any order and/or in any combination:

1. The present invention relates to a ceiling fan with an outer-rotor type DC brushless motor, comprising:
at least one blade, and an outer-rotor type DC brushless motor as a driving source for the ceiling fan, wherein the outer-rotor type DC brushless motor is mounted on a shaft and comprises a stator having an axis and multiple stator windings; and
a rotor assembly rotatably mounted on the shaft and comprising:
a circular casing with an inner periphery, and having a permanent magnet present on the inner periphery and interacting with the stator windings of the stator; and at least one bearing provided in the inner space of the circular casing and located beneath said stator, and wherein all bearings present are located on the same side of said stator,
and wherein a motor controller is optionally connected to at least one rotor position sensor to detect the position of the rotor or a portion of the permanent magnet and based on detected results, the motor controller accordingly changes current of the stator windings to produce magnetic fields required to drive the rotor assembly and the at least one blade.

2. The ceiling fan of any preceding or following embodiment/feature/aspect, wherein said motor controller is connected to at least one rotor position sensor.

3. The ceiling fan of any preceding or following embodiment/feature/aspect, wherein said motor controller uses a sensor-less arrangement for purposes of changing current of the stator windings.

4. The ceiling fan of any preceding or following embodiment/feature/aspect, wherein said rotor position sensor is a magnetism sensor that detects the polarity of the portion of the permanent magnet that is adjacent to said magnetism sensor.

5. The ceiling fan of any preceding or following embodiment/feature/aspect, wherein said rotor position sensor is connected to said motor controller without wires.

6. The ceiling fan of any preceding or following embodiment/feature/aspect, wherein said rotor position sensor is connected to said motor controller through electrical terminals.

7. The ceiling fan of any preceding or following embodiment/feature/aspect, wherein said rotor position sensor is mounted on a printed control board and is connected to said motor controller through electrical tracks on said printed control board.

8. The ceiling fan of any preceding or following embodiment/feature/aspect, wherein said at least one bearing comprises a top bearing and a bottom bearing provided in the inner space of the circular casing and both top bearing and bottom bearing are located beneath said stator to provide cantilever support of the rotor assembly.

9. The ceiling fan of any preceding or following embodiment/feature/aspect, wherein the top bearing and bottom bearing are spaced apart from each other.

10. The ceiling fan of any preceding or following embodiment/feature/aspect, wherein the top bearing and bottom bearing are accommodated in a single bearing bridge.

11. The ceiling fan of any preceding or following embodiment/feature/aspect, wherein no moving parts are located between the stator and the motor controller.

12. The ceiling fan of any preceding or following embodiment/feature/aspect, wherein the motor controller is connected through electrical terminals to the stator.

13. The ceiling fan of any preceding or following embodiment/feature/aspect, wherein the motor controller is a control printed circuit board or is part of a control printed circuit board.

14. The ceiling fan of any preceding or following embodiment/feature/aspect, wherein the stator is connected to said control printed circuit board.

15. The ceiling fan of any preceding or following embodiment/feature/aspect, wherein the stator is connected to said control printed circuit board through terminals that mate directly with terminals on said control printed circuit board.

16. The ceiling fan of any preceding or following embodiment/feature/aspect, wherein the motor controller is mounted over said stator.

17. A ceiling fan with an outer-rotor type DC brushless motor, comprising:
at least one blade; and
an outer-rotor type DC brushless motor as a driving source for the ceiling fan, wherein the outer-rotor type DC brushless motor is mounted on a shaft and comprises:
a stator having an axis and multiple stator windings; and
a rotor assembly rotatably mounted on the shaft and comprising:
a circular casing with an inner periphery, and having a permanent magnet mounted on the inner periphery and interacting with the stator windings of the stator; and at least one bearing provided in the inner space of the circular casing and wherein all bearings present are located on the same side of said stator,
and wherein a motor controller is optionally connected to at least one rotor position sensor to detect the position of the rotor or a portion of the permanent magnet and based on detected results, the motor controller accordingly changes current of the stator windings to produce magnetic fields required to drive the rotor assembly and the at least one blade.

18. The ceiling fan of any preceding or following embodiment/feature/aspect, wherein said motor controller is connected to at least one rotor position sensor.

19. The ceiling fan of any preceding or following embodiment/feature/aspect, wherein said motor controller uses a sensor-less arrangement for purposes of changing current of the stator windings.

20. The ceiling fan of any preceding or following embodiment/feature/aspect, wherein said at least one bearing is located above said stator and supports said rotor assembly.

21. The ceiling fan of any preceding or following embodiment/feature/aspect, wherein said rotor position sensor is a magnetism sensor that detects the polarity of the portion of the permanent magnet that is adjacent said magnetism sensor.

22. The ceiling fan of any preceding or following embodiment/feature/aspect, wherein said rotor position sensor is connected to said motor controller without wires.

23. The ceiling fan of any preceding or following embodiment/feature/aspect, wherein said rotor position sensor is connected to said motor controller through electrical terminals.

24. The ceiling fan of any preceding or following embodiment/feature/aspect, wherein said rotor position sensor is mounted on a printed control board and is connected to said motor controller through electrical tracks on said printed control board.

25. The ceiling fan of any preceding or following embodiment/feature/aspect, wherein said at least one bearing comprises a top bearing and a bottom bearing provided in the inner space of the circular casing and both top bearing and bottom bearing are located above said stator to provide cantilever support of the rotor assembly.

26. The ceiling fan of any preceding or following embodiment/feature/aspect, wherein the top bearing and bottom bearing are spaced apart from each other.

27. The ceiling fan of any preceding or following embodiment/feature/aspect, wherein the top bearing and bottom bearing are accommodated in a single bearing bridge.

28. The ceiling fan of any preceding or following embodiment/feature/aspect, wherein no moving parts are located between the stator and the motor controller.

29. The ceiling fan of any preceding or following embodiment/feature/aspect, wherein the motor controller is connected through electrical terminals to the stator and is located beneath said stator.

30. The ceiling fan of any preceding or following embodiment/feature/aspect, wherein the motor controller is a printed circuit board or is part of a control printed circuit board.

31. The ceiling fan of any preceding or following embodiment/feature/aspect, wherein the stator is connected to said control printed circuit board.

32. The ceiling fan of any preceding or following embodiment/feature/aspect, wherein the stator is connected to said control printed circuit board through terminals that mate directly with terminals on said control printed circuit board.

33. The ceiling fan of any preceding or following embodiment/feature/aspect, wherein the motor controller is mounted beneath said stator.

34. An electrical brushless motor comprising a stator having an axis and multiple stator windings; a circular casing with an inner periphery, and having a permanent magnet with alternating magnetic pole sections present on the inner periphery and interacting with the stator windings of the stator; and at least one bearing provided in an inner space of the circular casing and wherein all bearings present are located on the same side of said stator.

35. The electrical brushless motor of any preceding or following embodiment/feature/aspect, wherein said at least one bearing comprises a top bearing and a bottom bearing provided in the inner space of the circular casing and both top bearing and bottom bearing are located on the same side of said stator to provide cantilever support of a rotor.

36. The electrical brushless motor of any preceding or following embodiment/feature/aspect, wherein said at least one bearing provided in the inner space of the circular casing is located beneath said stator.

37. The electrical brushless motor of any preceding or following embodiment/feature/aspect, wherein said at least one bearing provided in the inner space of the circular casing is located above said stator.

38. The electrical brushless motor of any preceding or following embodiment/feature/aspect, wherein the top bearing and bottom bearing are spaced apart from each other.

39. The electrical brushless motor of any preceding or following embodiment/feature/aspect, wherein the top bearing and bottom bearing are accommodated in a single bearing bridge.

40. The electrical brushless motor of any preceding or following embodiment/feature/aspect, further comprising a motor controller and wherein no moving parts are located between the stator and the motor controller.

41. The electrical brushless motor of any preceding or following embodiment/feature/aspect, wherein the motor controller is connected through electrical terminals to the stator.

42. The electrical brushless motor of any preceding or following embodiment/feature/aspect, wherein the motor controller is a printed circuit board.

43. The electrical brushless motor of any preceding or following embodiment/feature/aspect, further comprising a rotor position sensor.

44. The electrical brushless motor of any preceding or following embodiment/feature/aspect, wherein said rotor position sensor is a magnetism sensor that detects the polarity of the portion of the permanent magnet that is adjacent said magnetism sensor.

45. The electrical brushless motor of any preceding or following embodiment/feature/aspect, wherein said rotor position sensor is connected to said motor controller without wires.

46. The electrical brushless motor of any preceding or following embodiment/feature/aspect, wherein said rotor position sensor is connected to said motor controller through electrical terminals.

47. The electrical brushless motor of any preceding or following embodiment/feature/aspect, wherein the rotor position sensor is mounted directly on a control printed circuit board.

48. The electrical brushless motor of any preceding or following embodiment/feature/aspect, further comprising a motor controller that is a control printed circuit board or part of a control printed circuit board and wherein said stator is connected to said control printed circuit board.

49. The electrical brushless motor of any preceding or following embodiment/feature/aspect, further comprising a motor controller, and wherein the motor controller is a control printed circuit board and the stator is connected to said control printed circuit board through terminals that mate directly with terminals on said control printed circuit board.

50. The electrical brushless motor of any preceding or following embodiment/feature/aspect, further comprising a motor controller, and wherein the motor controller is mounted over said stator.

51. The electrical brushless motor of any preceding or following embodiment/feature/aspect, further comprising a motor controller, and wherein the motor controller is mounted below said stator.

52. The ceiling fan of any preceding or following embodiment/feature/aspect, wherein the permanent magnet has 8 or more magnetic poles.

53. The ceiling fan of any preceding or following embodiment/feature/aspect, wherein said permanent magnet has 22 magnetic poles.

54. The ceiling fan of any preceding or following embodiment/feature/aspect, wherein the circular casing has an overhang of from 10 mm to 30 mm.

55. The ceiling fan of any preceding or following embodiment/feature/aspect, wherein said motor controller is part of a skirt that removably connects to the stator.

56. The ceiling fan of any preceding or following embodiment/feature/aspect, wherein said axis is a hollow shaft with an outer diameter of from 8 mm to 15 mm and an inner diameter of from 5 mm to 9.5 mm.

57. The ceiling fan of any preceding or following embodiment/feature/aspect, wherein said axis is a hollow shaft with an outer diameter of from 8 mm to 12 mm and an inner diameter of from 5 mm to 8 mm.

58. The ceiling fan of any preceding or following embodiment/feature/aspect, wherein said circular casing includes a flux ring, wherein said permanent magnet is present.

59. The ceiling fan of any preceding or following embodiment/feature/aspect, wherein said permanent magnet has multiple spaced raised portions capable of being detected by at least one rotor-position sensor.

60. The electrical brushless motor of any preceding or following embodiment/feature/aspect, wherein said circular casing includes a flux ring, wherein said permanent magnet is present.

61. The electrical brushless motor of any preceding or following embodiment/feature/aspect, wherein said permanent magnet has multiple spaced raised portions capable of being detected by at least one rotor-position sensor.

62. The ceiling fan or electrical brushless motor of any preceding or following embodiment/feature/aspect, wherein said shaft is a solid shaft.

63. The electrical brushless motor or ceiling fan of any preceding or following embodiment/feature/aspect, wherein said stator is connected to a separate printed circuit board and, in turn, the separate printed circuit board is connected to a control printed circuit board, wherein the connection can be by wires, solder, electrical terminals, and the like.

64. The electrical brushless motor or ceiling fan of any preceding or following embodiment/feature/aspect, wherein said rotor position sensor is an optical sensor or other sensor capable of detecting rotor movement or magnetic poles.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A ceiling fan with an outer-rotor type DC brushless motor, comprising:
at least one blade, and an outer-rotor type DC brushless motor as a driving source for the ceiling fan, wherein the outer-rotor type DC brushless motor is mounted on a shaft and comprises a stator having an axis and multiple stator windings; and
a rotor assembly rotatably mounted on the shaft and comprising:
a circular casing with an inner periphery, and having a permanent magnet present on the inner periphery and interacting with the stator windings of the stator; and at least one bearing provided in the inner space of the circular casing and located beneath said stator, and wherein all bearings present are located on the same side of said stator,
and wherein a motor controller is optionally connected to at least one rotor position sensor to detect the position of the rotor or a portion of the permanent magnet and based on detected results, the motor controller accordingly changes current of the stator windings to produce magnetic fields required to drive the rotor assembly and the at least one blade.

2. The ceiling fan of claim 1, wherein said motor controller is present and is connected to at least one rotor position sensor.

3. The ceiling fan of claim 1, wherein said motor controller uses a sensor-less arrangement for purposes of changing current of the stator windings.

4. The ceiling fan of claim 1, wherein said rotor position sensor is a magnetism sensor that detects the polarity of the portion of the permanent magnet that is adjacent to said magnetism sensor.

5. The ceiling fan of claim 1, wherein said rotor position sensor is connected to said motor controller without wires.

6. The ceiling fan of claim 1, wherein said rotor position sensor is connected to said motor controller through electrical terminals.

7. The ceiling fan of claim 1, wherein said rotor position sensor is mounted on a printed control board and is connected to said motor controller through electrical tracks on said printed control board.

8. The ceiling fan of claim 1, wherein said at least one bearing comprises a top bearing and a bottom bearing provided in the inner space of the circular casing and both top bearing and bottom bearing are located beneath said stator to provide cantilever support of the rotor assembly.

9. The ceiling fan of claim 8, wherein the top bearing and bottom bearing are spaced apart from each other.

10. The ceiling fan of claim 8, wherein the top bearing and bottom bearing are accommodated in a single bearing bridge.

11. The ceiling fan of claim 1, wherein no moving parts are located between the stator and the motor controller.

12. The ceiling fan of claim 1, wherein the motor controller is connected through electrical terminals to the stator.

13. The ceiling fan of claim 1, wherein the motor controller is a control printed circuit board or is part of a control printed circuit board.

14. The ceiling fan of claim 13, wherein the stator is connected to said control printed circuit board.

15. The ceiling fan of claim 13, wherein the stator is connected to said control printed circuit board through terminals that mate directly with terminals on said control printed circuit board.

16. The ceiling fan of claim 1, wherein the motor controller is mounted over said stator.

17. A ceiling fan with an outer-rotor type DC brushless motor, comprising:
at least one blade; and
an outer-rotor type DC brushless motor as a driving source for the ceiling fan, wherein the outer-rotor type DC brushless motor is mounted on a shaft and comprises:
a stator having an axis and multiple stator windings; and
a rotor assembly rotatably mounted on the shaft and comprising:
a circular casing with an inner periphery, and having a permanent magnet mounted on the inner periphery and interacting with the stator windings of the stator; and at least one bearing provided in the inner space of the circular casing and wherein all bearings present are located on the same side of said stator,
and wherein a motor controller is optionally connected to at least one rotor position sensor to detect the position of the rotor or a portion of the permanent magnet and based on detected results, the motor controller accordingly changes current of the stator windings to produce magnetic fields required to drive the rotor assembly and the at least one blade.

18. The ceiling fan of claim 17, wherein said motor controller is present and is connected to at least one rotor position sensor.

19. The ceiling fan of claim 17, wherein said motor controller uses a sensor-less arrangement for purposes of changing current of the stator windings.

20. The ceiling fan of claim 17, wherein said at least one bearing is located above said stator and supports said rotor assembly.

21. The ceiling fan of claim 17, wherein said rotor position sensor is a magnetism sensor that detects the polarity of the portion of the permanent magnet that is adjacent said magnetism sensor.

22. The ceiling fan of claim 17, wherein said rotor position sensor is connected to said motor controller without wires.

23. The ceiling fan of claim 17, wherein said rotor position sensor is connected to said motor controller through electrical terminals.

24. The ceiling fan of claim 17, wherein said rotor position sensor is mounted on a printed control board and is connected to said motor controller through electrical tracks on said printed control board.

25. The ceiling fan of claim 17, wherein said at least one bearing comprises a top bearing and a bottom bearing provided in the inner space of the circular casing and both top bearing and bottom bearing are located above said stator to provide cantilever support of the rotor assembly.

26. The ceiling fan of claim 25, wherein the top bearing and bottom bearing are spaced apart from each other.

27. The ceiling fan of claim 25, wherein the top bearing and bottom bearing are accommodated in a single bearing bridge.

28. The ceiling fan of claim 17, wherein no moving parts are located between the stator and the motor controller.

29. The ceiling fan of claim 17, wherein the motor controller is connected through electrical terminals to the stator and is located beneath said stator.

30. The ceiling fan of claim 17, wherein the motor controller is a printed circuit board or is part of a control printed circuit board.

31. The ceiling fan of claim 30, wherein the stator is connected to said control printed circuit board.

32. The ceiling fan of claim 30, wherein the stator is connected to said control printed circuit board through terminals that mate directly with terminals on said control printed circuit board.

33. The ceiling fan of claim 17, wherein the motor controller is mounted beneath said stator.

34. An electrical brushless motor comprising a stator having an axis and multiple stator windings; a circular casing with an inner periphery, and having a permanent magnet with alternating magnetic pole sections present on the inner periphery and interacting with the stator windings of the stator; and at least one bearing provided in an inner space of the circular casing and wherein all bearings present are located on the same side of said stator.

35. The electrical brushless motor of claim 34, wherein said at least one bearing comprises a top bearing and a bottom bearing provided in the inner space of the circular casing and both top bearing and bottom bearing are located on the same side of said stator to provide cantilever support of a rotor.

36. The electrical brushless motor of claim 34, wherein said at least one bearing provided in the inner space of the circular casing is located beneath said stator.

37. The electrical brushless motor of claim 34, wherein said at least one bearing provided in the inner space of the circular casing is located above said stator.

38. The electrical brushless motor of claim 35, wherein the top bearing and bottom bearing are spaced apart from each other.

39. The electrical brushless motor of claim 35, wherein the top bearing and bottom bearing are accommodated in a single bearing bridge.

40. The electrical brushless motor of claim 34, further comprising a motor controller and wherein no moving parts are located between the stator and the motor controller.

41. The electrical brushless motor of claim 40, wherein the motor controller is connected through electrical terminals to the stator.

42. The electrical brushless motor of claim 40, wherein the motor controller is a printed circuit board.

43. The electrical brushless motor of claim 34, further comprising a rotor position sensor.

44. The electrical brushless motor of claim 43, wherein said rotor position sensor is a magnetism sensor that detects the polarity of the portion of the permanent magnet that is adjacent said magnetism sensor.

45. The electrical brushless motor of claim 43, wherein said rotor position sensor is connected to said motor controller without wires.

46. The electrical brushless motor of claim 43, wherein said rotor position sensor is connected to said motor controller through electrical terminals.

47. The electrical brushless motor of claim 43, wherein the rotor position sensor is mounted directly on a control printed circuit board.

48. The electrical brushless motor of claim 34, further comprising a motor controller that is a control printed circuit board or part of a control printed circuit board and wherein said stator is connected to said control printed circuit board.

49. The electrical brushless motor of claim 34, further comprising a motor controller, and wherein the motor controller is a control printed circuit board and the stator is connected to said control printed circuit board through terminals that mate directly with terminals on said control printed circuit board.

50. The electrical brushless motor of claim 34, further comprising a motor controller, and wherein the motor controller is mounted over said stator.

51. The electrical brushless motor of claim 34, further comprising a motor controller, and wherein the motor controller is mounted below said stator.

52. The ceiling fan of claim 1, wherein the permanent magnet has 8 or more magnetic poles.

53. The ceiling fan of claim 1, wherein the permanent magnet has 22 magnetic poles.

54. The ceiling fan of claim 1, wherein the circular casing has an overhang of from 10 mm to 30 mm.

55. The ceiling fan of claim 13, wherein said motor controller is part of a skirt that removably connects to the stator.

56. The ceiling fan of claim 1, wherein said axis is a hollow shaft with an outer diameter of from 8 mm to 15 mm and an inner diameter of from 5 mm to 9.5 mm.

57. The ceiling fan of claim 1, wherein said axis is a hollow shaft with an outer diameter of from 8 mm to 12 mm and an inner diameter of from 5 mm to 8 mm.

58. The ceiling fan of claim 1, wherein said circular casing includes a flux ring, wherein said permanent magnet is present.

59. The ceiling fan of claim 1, wherein said permanent magnet has multiple spaced raised portions capable of being detected by at least one rotor-position sensor.

60. The ceiling fan of claim 17, wherein said circular casing includes a flux ring, wherein said permanent magnet is present.

61. The ceiling fan of claim 17, wherein said permanent magnet has multiple spaced raised portions capable of being detected by at least one rotor-position sensor.

62. The electrical brushless motor of claim 34, wherein said circular casing includes a flux ring, wherein said permanent magnet is present.

63. The electrical brushless motor of claim 34, wherein said permanent magnet has multiple spaced raised portions capable of being detected by at least one rotor-position sensor.
